(19) United States
(12) Patent Application Publication
(10) Pub. No.: US 2024/0062071 A1
(43) Pub. Date: Feb. 22, 2024

(54) SYSTEMS AND METHODS FOR SEQUENTIAL RECOMMENDATION WITH CASCADE-GUIDED ADVERSARIAL TRAINING

(71) Applicant: Salesforce, Inc., San Francisco, CA (US)

(72) Inventors: Juntao TAN, Palo Alto, CA (US); Shelby Heinecke, Palo Alto, CA (US); Zhiwei Liu, Palo Alto, CA (US); Yongjun Chen, Palo Alto, CA (US)

(21) Appl. No.: 18/148,735

(22) Filed: Dec. 30, 2022

Related U.S. Application Data
(60) Provisional application No. 63/399,505, filed on Aug. 19, 2022.

(51) Int. Cl. G06N 3/094; G06N 3/084

(52) U.S. Cl. CPC G06N 3/094; G06N 3/084

(57) ABSTRACT

Embodiments described herein provide a cascade-guided adversarial training method for sequential recommendation models. A system may compute cascade scores for items in a user interaction sequence. The cascade scores may be based on the position in the sequence, as well as the appearance of the same item in other sequences. Based on the computed cascade score, the system may perturb item embeddings. The perturbed user interaction sequences with perturbed item embeddings may be used to train a sequential recommendation model.

### CROSS REFERENCE(S)

The instant application is a nonprovisional of and claim priority under 35 U.S.C. 119 to U.S. provisional application No. 63/399,505, filed Aug. 19, 2022, which is hereby expressly incorporated by reference herein in its entirety.

### TECHNICAL FIELD

The embodiments relate generally to natural language processing and machine learning systems, and more specifically to systems and methods for sequential recommendation with cascade-guided adversarial training.

### BACKGROUND

Sequential recommendation models provide a sequence of recommended items that capture item relationships and behaviors of users, e.g., recommending a water bottle holder after a user purchases a water bottle. Sequential recommendation models, however, may not be robust to noise on input data. Specifically, sequential recommendation models suffer from unique robustness and stability issues. Due to sequential recommendation models being trained in their time-aware regime, the user-item interactions in early timestamps appear early in each training epoch, and have large cascade effects on the interaction compared to later interactions in a sequence. In this way, the gradients are computed more frequently for “early” interactions and the trained model could be more robust to such interactions. This directly contradicts what happens at inference time, in which interactions at the end of a user sequence contributes more to the final recommendation. This could potentially hurt the stability of the model and limit the ranking accuracy. Therefore, there is a need for improved systems and methods for training sequential recommendation models which provide a more robust response to perturbations.

### BRIEF DESCRIPTION OF THE DRAWINGS

FIG. 1A is a simplified diagram illustrating a sequential recommending model, according to some embodiments

FIG. 1B is a simplified diagram illustrating a sequential recommending model with perturbations, according to some embodiments

FIG. 2 is a simplified diagram illustrating a computing device implementing the adversarial training framework according to one embodiment described herein.

FIG. 3 is a simplified block diagram of a networked system suitable for implementing the adversarial training framework according to some embodiments.

FIG. 4 illustrates an example of applying adversarial training on sequential recommendation according to some embodiments.

FIG. 5 illustrates an example of calculating cascade effects according to some embodiments.

FIG. 6 provides an example logic flow diagram illustrating an example algorithm for a method of federated learning according to some embodiments described herein.

FIGS. 7A-11H provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Sequential recommendation models provide a sequence of recommended items that capture item relationships and behaviors of users, e.g., recommending a water bottle holder after a user purchases a water bottle. Sequential recommendation models, however, may not be robust to attacks, or perturbations, on input data. Specifically, the cascade effects induced during training, in which gradients are computed and model parameters updated more frequently for early interactions. Further, the model's tendency to rely too heavily on temporal information cause sequential recommendation models to suffer from unique robustness and stability issues. Further, more training data may be required for training complex models. While complicated neural network structures and a large number of model parameters are used in the deep sequential models, datasets in recommendation are typically sparse. This may cause stability concerns in deep sequential recommendation models.

Due to sequential recommendation models being trained in their time-aware regime, the user-item interactions in early timestamps appear early in each training epoch, and have large cascade effects on the interaction compared to later interactions in a sequence. In this way, the gradients are computed more frequently for “early” interactions and the trained model could be more robust to such interactions. This directly contradicts what happens at inference time, in which interactions at the end of a user sequence contributes more to the final recommendation. This discrepancy may potentially hurt the stability of the model and limit the ranking accuracy. Further, the trained model will be more vulnerable to perturbations (e.g., noise) at the end of each sequence.

In view of the need for improved systems and methods for training sequential recommendation models, embodiments described herein provide a cascade-guided adversarial training framework for sequential recommendation models. A sequential recommendation model may be trained using input training sequences, where the embeddings of items in the sequence are perturbed to a degree that is inversely proportional to a measure of the respective item's cascade effects. Since interactions with lower cascade effects are trained less but contribute more during testing, the basic idea is to increase the stability for such low-cascade interactions by adding more noise on them during training.

Embodiments described herein provide a number of benefits. For example, the resulting model may be more stable and robust noisy training data. The resulting model will be especially more robust to perturbations towards the end of a sequence compared to adversarial training methods that do not scale perturbations based on cascade effects. The overall accuracy of the model may also be improved. The increased robustness for a given amount of training data may allow models to be trained with fewer training data and/or fewer training iterations, conserving memory and compute resources.

### Overview

A method of training a sequential recommendation model may use input training sequences, and train a model to predict the next item at each step of each sequence. For example, for a sequence of 10 items, the first item may be input to the model, and the output of the model may be compared to the second item of the sequence as a positive (ground truth) next item. Then the same sequence may be used by inputting the first two items into the model, and train the model to predict the third item in that sequence and so on. In some embodiments, a “negative” sample may also be used in training, which may be selected either randomly, or a “hard” negative sample may be selected more intelligently.

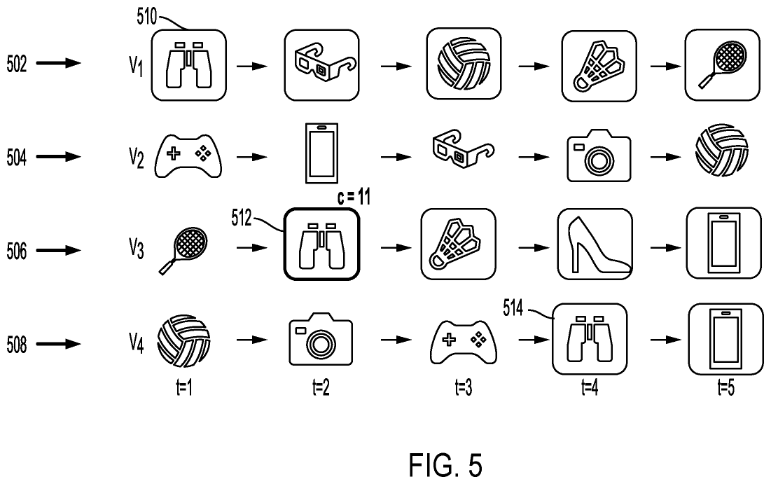

As is shown in the description above, items early in each sequence may contribute more to the training of a model as they appear more often in the training steps. This may result in a model being more robust to noise early in the training sequences, but not as robust to noise which appears later in sequences, as they are trained less. In order to counteract this effect, synthetic noise may be added to items (or item embeddings) in sequences inversely proportional to their cascade effect, which may be determined by computing a cascade score for each item. Different methods may be used to compute a cascade score, but generally the computation reflects the amount of relative effect the item has on the training of the model. For example, cascade scores may be computed based on the position of each individual item in the input sequence, e.g., items later in a sequence often have lesser cascade effects during training. A simple cascade score may be computed by determining the number of items in the sequence past the item for which the cascade score is being computed. In general, a cascade score may be higher for earlier items, and relatively lower for later items. In other embodiments, the position of the same item in other input sequences may be used to adjust the cascade score, as discussed in further detail in FIG. 5.

The computed cascade scores may be used to add noise (i.e., perturb) item embeddings in order to add perturbations to item embeddings, generated by an encoder of a sequential recommendation model, scaled based on the respective cascade scores. For example, a worst-case direction vector may be scaled based on the cascade score, and added to the item embedding vector. The modified item embeddings may then be used to train the sequential recommendation model. For example, a loss function may be computed which compares perturbed to unperturbed sequence embeddings, such that the model learns to minimize the contribution to an embedding that a perturbation causes. Additional perturbations and losses may be computed which contribute to the training of the model to further increase the robustness, as is discussed in more detail below. The resulting model will be especially more robust to perturbations towards the end of a sequence compared to adversarial training methods that do not scale perturbations based on cascade effects.

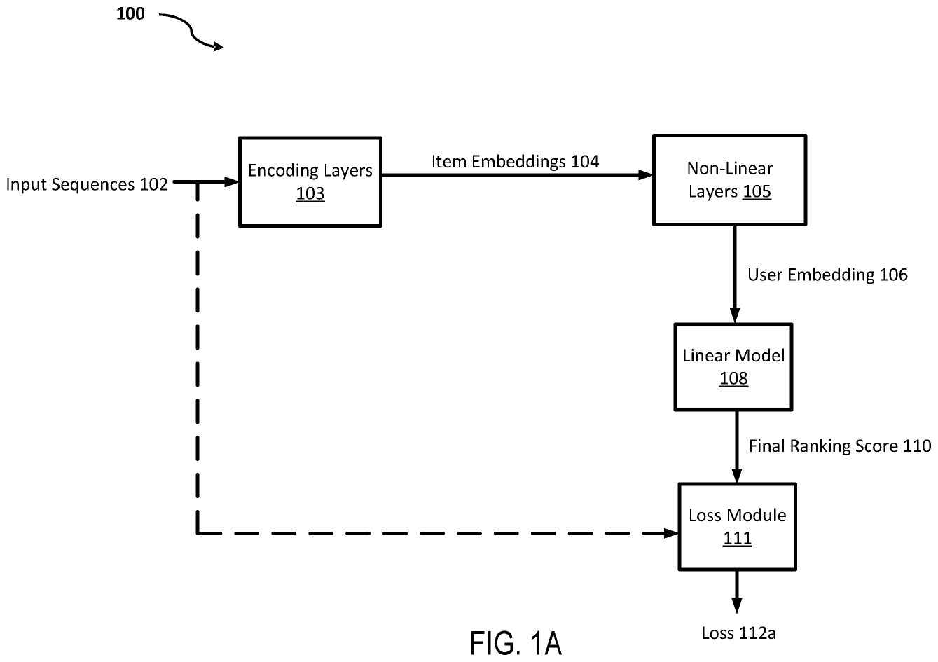

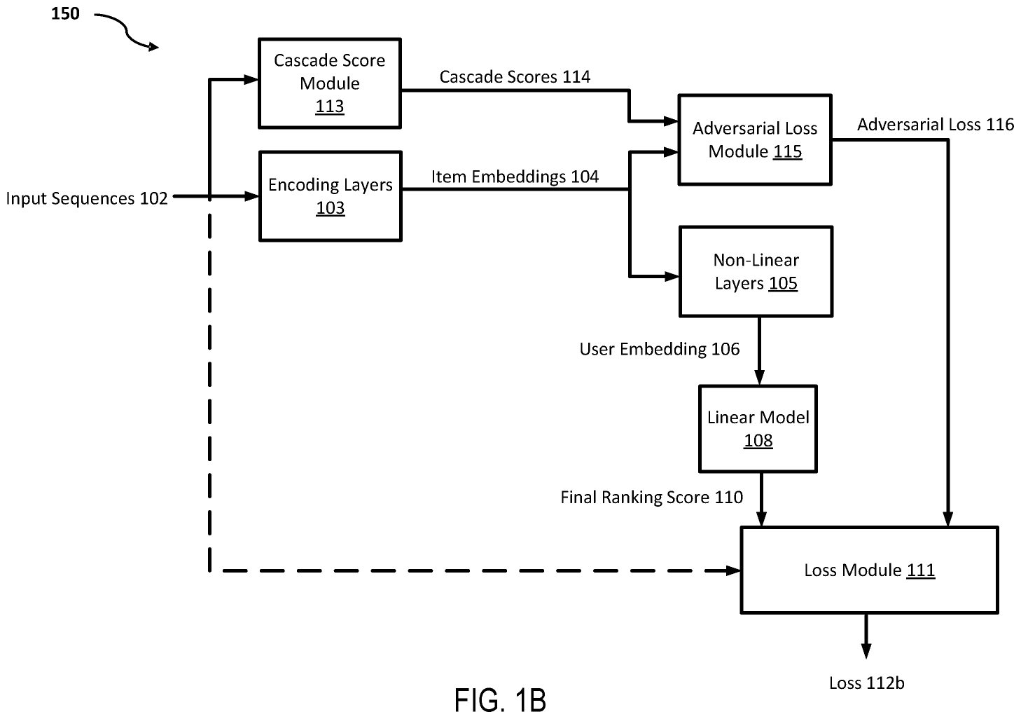

FIG. 1A is a simplified diagram illustrating a sequential recommending model 100, according to some embodiments. As shown in FIG. 1, a deep sequential recommendation model 100 is a hierarchy comprising encoding layers 103 that embed an input sequence 102 of items that a user historically interacted with into item embeddings 104, non-linear layers 105 that take the item embeddings 104 as input and outputs the user embedding 106, and a linear model 108 that predicts the final ranking score 110 for user i on target item vⱼ by linearly multiplying their embeddings. Loss module 111 compares the final ranking score 110 to the ground truth next sequence item in order to calculate a loss 112a. In some embodiments, a negative sample is also compared in the loss calculation as discussed in more detail in FIG. 1B. The loss 112a may be used to update parameters of the sequential recommendation model (e.g., parameters of encoding layers 103, non-linear layers 105, and linear model 108). In this embodiment, no perturbations are added during the training process.

FIG. 1B is a simplified diagram illustrating a sequential recommendation model 150 with perturbations according to some embodiments. As in FIG. 1A, encoding layers 103 embed an input sequence 102 of items that a user historically interacted with into item embeddings 104, non-linear layers 105 that take the item embeddings 104 as input and outputs the user embedding 106, and a linear model 108 that predicts the final ranking score 110 for user i on target item vⱼ by linearly multiplying their embeddings.

Model 150 also includes cascade score module 113 which computes a cascade scores 114 for each item in input sequences 102. Adversarial loss module 115 perturbs item embeddings 104 according to their corresponding cascade scores. The perturbed item embeddings are compared to the non-perturbed item embeddings 104 in order to compute an adversarial loss 116. In some embodiments, for the comparison, each sequence is encoded to produce a user embedding (both perturbed and unperturbed accordingly), and the user embeddings are compared. Since adversarial loss 116 is computed based on an intermediate result, and not the final ranking score 110, the training method utilizing adversarial loss 116 may be considered “virtual” adversarial training.

As in model 100, loss module 111 compares the final ranking score 110 to the ground truth next sequence item in order to calculate a loss, however in model 150, loss 112b also includes a contribution by the adversarial loss 116. Additional losses may be included which are not illustrated, such as additional adversarial losses computed by perturbing other features such as negative sample embeddings, user embeddings, and target item embeddings. The loss 112b may be used to update parameters of the sequential recommendation model (e.g., parameters of encoding layers 103, non-linear layers 105, and linear model 108).

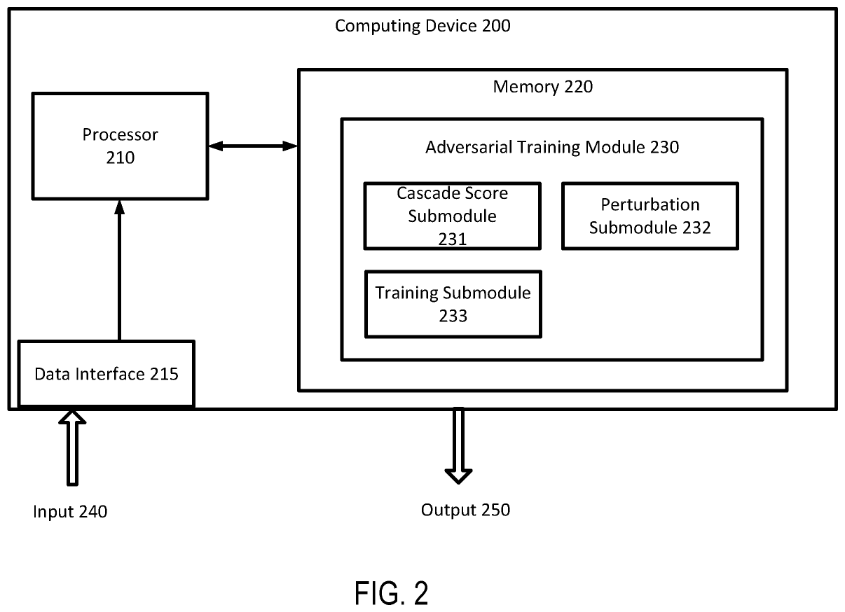

In some embodiments, adversarial training is performed as a second training step after an initial training is performed without the adversarial loss. For example, training may be performed as in FIG. 1A until the model converges, and then training may continue with one or more adversarial losses as in FIG. 2A.

A formal, more detailed description of an embodiment of a cascade-guided training method follows. Consider a general classification problem with [symbol] -dimensional input data x∈ [symbol] ^{d} and corresponding label y∈ [symbol] under data distribution D. For a classification model f [symbol] , the training goal is to minimize the risk [symbol] _{x,y˜D}[L(f_{θ}(x),y)]. Adversarial training aims to find a perturbation [symbol] with bounded norm ∥δ∥<ϵ that maximizes the minimum risk with respect to [symbol] . This can be summarized as the following min-max equation:

$${min}_{θ} ( {max}_{δ , ‖ δ ‖ < ϵ} {x , y \sim D}_{} [ L ( {f}_{θ} ( x + δ ) , y ) ] ) \qquad ( 1 )$$

In one embodiment, the optimal [symbol] is calculated using a fast gradient sign method (FGSM). FGSM generates adversarial perturbations by multiplying the sign of the gradient of the loss function by the maximal perturbation magnitude, [symbol] :

δ=ϵ·sign(∇L(f_{θ}(x+δ),y)) (2)

The minimized adversarial training loss function (e.g., adversarial loss 116) is not necessarily the same as the general training loss function (e.g. loss 112a). As used in some embodiments, the adversarial training only minimizes the statistical distance between the original and new predicted probability distributions (e.g., as described with reference to adversarial loss module 115), regardless of the correctness of the original prediction (e.g., final ranking score 110) This is also referred to as virtual adversarial training, as discussed above.

For a formulation of input sequences (e.g., input sequences 102), let i∈[1, m] denote the index of a user and [symbol] ={v₁, v₂, . . . , vₙ} denote the set of all possible items. User i has a sequentially ordered interaction history of length T, [symbol] ᵢ={vᵢ^{t}|t=1, . . . , T}. In practice, each user has different length of history. T is a hyper parameter that decides the maximum length of user history, such that only the last T interactions is considered when making predictions. A sequential recommendation model may receive an input sequence of the user-item interaction history and generate the embedding for each item (e.g., item embeddings 104) represented as vᵢ in the input sequence, denoted as eᵢ. For example, the item embedding may be the hidden state of the last layer of the encoder (e.g., encoding layers 103) in the sequential recommendation model. Together, these embeddings form the item embedding matrix, E∈ [symbol] ^{n×d}. For each user i, the sequence of embeddings of items in [symbol] ᵢ (the items that the user i has interacted with in the user-item history) is concatenated, denoted as Sᵢ=[eᵢ^{t}|t=1, . . . , T]. The sequential model then generates a user embedding, wᵢ, as a function of the sequence embeddings (e.g., user embedding 106),

wᵢ=f(Sᵢ;θ), (3)

where f denotes a sequence embedding model and θ denotes the model parameters. In sequential recommender systems, f can be a Recurrent Neural Network (RNN), Convolutional Neural Network (CNN), an Attention mechanism, etc. After generating wᵢ, for a target item vⱼ where the target item vⱼ appears in the sequence of items [symbol] ᵢ, the ranking score (e.g., final ranking score 110) denoted as r_{i,j} is predicted (e.g., as in linear model 108) by

r_{i,j}=wᵢ^{T}eⱼ. (4)

During model training, for each user i with target item vⱼ and a set of negative samples N⁻⊂ [symbol] \vⱼ that user i has not interacted with, a loss may be computed, for example, as a binary cross entropy (BCE) loss defined as:

$${L}_{B} ( i , j , {N}^{-} ; θ , E ) = - ( log ( σ ( {r}_{i , j} ) ) + {\sum }_{{v}_{n} ∈ {N}^{-}} log ( 1 - σ ( {r}_{i , n} ) ) \qquad ( 5 )$$

where σ is the sigmoid function

In one embodiment, during training, the user sequence [symbol] ᵢ is truncated according to each timestamp t. For each subsequence, item vᵢ^{t} is treated as the target item and the ranking score is predicted by taking previous items as dynamic user history. Meanwhile, only one negative item [symbol] ₙ is sampled for each vᵢ^{t} in each sub-sequence. For simplicity, [symbol] ⱼ to user i with negative sample [symbol] ₙ is denoted as L_{B}(i,j,n). The loss (e.g., loss 112b) may be used to update parameters of the sequential recommendation model, for example by backpropagation.

As shown in FIG. 1B, the sequential recommendation model 150 takes discrete input data (i.e., a sequence of user/item IDs 102), and applies adversarial perturbations to the latent embeddings. Sequential recommendation model 150 is a hierarchy consisting of two levels: (1) a non-linear deep neural network (e.g., 105) that takes the item embeddings 104 of the user's history Sᵢ as input and outputs the user embedding wᵢ 106 (2) a linear model 108 that predicts the final ranking score 110 for user i on target item [symbol] ⱼ by linearly multiplying their embeddings as wᵢ^{t}eⱼ. Adversarial training may be applied on either level (e.g., perturbation on item embeddings 104, or user embedding 106), or on both levels separately.

For the first level, the adversarial training objective is described as follows. When perturbing the item embeddings in the history sequence within a certain small magnitude, even in the worst case, the learned user embedding may be similar to the original prediction. For user i with sequence embeddings Sᵢ 104, the adversarial perturbations may be applied on the sequence embeddings as Aᵢ=[δᵢ^{t}|t=1, . . . , T], where δᵢ^{t} is the perturbation applied on the corresponding item embedding et. Then the nonlinear layer 105 may generate a user embedding \tilde{w}ᵢ from the perturbed sequence embedding. An adversarial loss 116 may then be computed as the difference between the user embedding 106 before and after the perturbation:

$${L}_{a d v - 1} ( i , {A}_{i} ) = {‖ {\tilde{w}}_{i} - {w}_{i} ‖}_{2} \qquad ( 6 )$$

$$Where {w}_{i} = f ( {S}_{i} ; θ ) , {\tilde{w}}_{i} = f ( {S}_{i} + \frac{1}{{c}_{i}} ⊙ {A}_{i} ; θ )$$

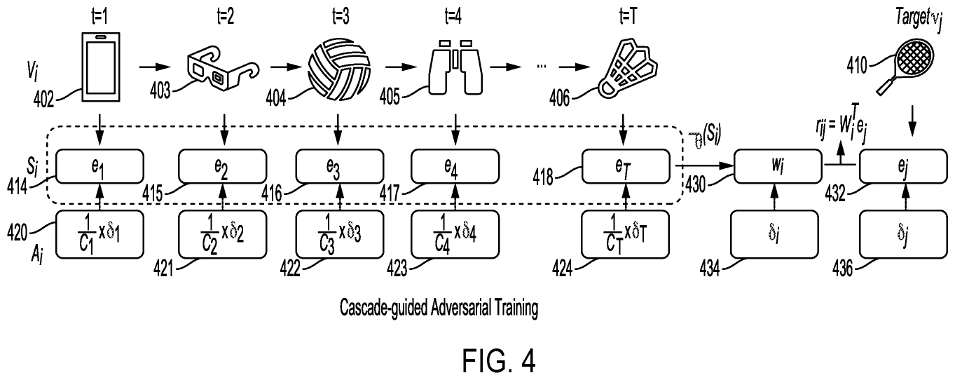

In Eq (6), the vector cᵢ∈[1+∞)^{T} denotes the cascade effects of each interaction in user i's history as calculated. Higher values of ci denote higher cascade effects. Additional details on calculating these cascade effects will be discussed in more detail with respect to FIGS. 4-5. The factor 1/cᵢ re-scales the adversarial perturbations so that interactions with smaller cascade effects will receive a larger adversarial perturbation. During sequential recommendation model training, interactions with larger cascade effects are used more often in training than interactions with smaller cascade effects, hence, the latter can be more vulnerable and unstable. By applying larger perturbations on the interactions with lower cascade effects, a model is obtained that is more equally robust across all sequence embeddings.

To approximate the worst case adversarial perturbation Aᵢ, the FGSM introduced in Eq.(2) may be applied:

$${𝒜}_{i} = ϵ \frac{g}{{‖ g ‖}_{2}} where g = \frac{\partial {L}_{a d v - 1} ( i , {A}_{i} )}{\partial {S}_{i}} \qquad ( 7 )$$

Note that

$$\frac{g}{{‖ g ‖}_{2}}$$

is the sign of the direction of the applied perturbation and ϵ is a human defined parameter to determine the general magnitude of perturbation. The specific magnitude of the perturbation on each interaction will be re-scaled by their cascade effects, which is one feature of some embodiments.

For adversarial training applied on the second level, perturbations may be applied on the user embedding 106, negative item embeddings, and/or the target item embeddings. This may help assure that when small changes are applied to those embeddings, the model is still able to generate highly accurate recommendation results. A loss function such as BCE loss may be used as the second adversarial training loss, which may be the same loss function used to train the sequential recommendation model 100 without adversarial training. Suppose δᵢ, δⱼ, δₙ are the adversarial perturbations applied on the embeddings of the user i, target item vⱼ, and negative sampled item vₙ, respectively. The second adversarial training loss (not illustrated) may be computed as a binary-cross entropy loss based on the output distribution of the ranking scores of user i for target item vⱼ given all the perturbed embeddings of the user i, target item vⱼ, and negative sampled item vₙ,

L_{adv-2}(i,j,n,δᵢ,δⱼ,δₙ)=−(log(σ(\hat{r}_{i,j}))+log(1−σ(\hat{r}_{i,n}))

Where \hat{r}_{i,j}=(wᵢ^{T}+δᵢ)(eⱼ+δₖ), \hat{r}_{i,n}=(wᵢ^{T}+δᵢ)(eₙ+δₙ) (8)

Here \tilde{r}_{i,k}, is the predicted ranking score for any user i and item k after perturbation. Similarly, the approximate worst case δᵢ, δⱼ, δₙ and on may be generated within maximum magnitude ϵ by:

$$\begin{matrix}{δ}_{i} = ϵ \frac{{h}_{i}}{{‖ {h}_{i} ‖}_{2}} where {h}_{i} = \frac{\partial {L}_{adv - 2} ( i , j , n , {δ}_{i} , {δ}_{j} , {δ}_{n} )}{\partial {e}_{i}} \\ {δ}_{i} = ϵ \frac{{h}_{j}}{{‖ {h}_{j} ‖}_{2}} where {h}_{j} = \frac{\partial {L}_{adv - 2} ( i , j , n , {δ}_{i} , {δ}_{j} , {δ}_{n} )}{\partial {e}_{j}} \\ {δ}_{n} = ϵ \frac{{h}_{n}}{{‖ {h}_{n} ‖}_{2}} where {h}_{n} = \frac{\partial {L}_{adv - 2} ( i , j , n , {δ}_{i} , {δ}_{j} , {δ}_{n} )}{\partial {e}_{n}}\end{matrix} \qquad ( 9 )$$

The two adversarial training objectives synergistically improve the robustness of the trained model with respect to all the components. Finally, the model parameters may be optimized by minimizing the sum of original BCE loss 112a as discussed in FIG. 1A, adversarial loss 116, and additional adversarial training losses which may include losses with respect to perturbations on user embeddings, negative item embeddings, and/or target item embeddings, represented as loss 112b:

$${min}_{θ , E} L = {L}_{B} ( i , j , n ) + {λ}_{1} {L}_{a d v - 1} ( i , {A}_{i} ) + {λ}_{2} {L}_{a d v - 2} ( i , j , n , {δ}_{i} , {δ}_{j} ) \qquad ( 10 )$$

The parameters of the non-linear model 105 and the item embedding matrix generated by the encoding layers 103 may be updated based on the final loss via backpropagation.

Note that the model may be trained with a subset of the three losses. For example, it may be trained, and achieve many or all of the same benefits. Also note that since the cascade effects only affect the model after the general training process, the adversarial training may be applied after the base recommendation has converged. In the adversarial training phase, by minimizing Eq. (10), the model may learn better item embeddings E and the model parameters θ such that the model is more accurate and robust.

### Computer and Network Environment

FIG. 2 is a simplified diagram illustrating a computing device implementing the cascade-guided adversarial training framework according to one embodiment described herein. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for adversarial training module 230 that may be used to implement and/or emulate the systems and models, and/or to implement any of the methods described further herein. An adversarial training module 230 may receive input 240 such as an input training data (e.g., user interaction sequences) via the data interface 215 and generate an output 250 which may be a sequential recommendation model, or at inference a recommendation.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as user interaction sequences, from a user via the user interface.

In some embodiments, the adversarial training module 230 is configured to train a sequential recommendation model as described herein (e.g., as in FIG. 1B). The adversarial training module 230 may further include a cascade score submodule 231 (e.g., similar to cascade score module 113 in FIG. 1B). Cascade score submodule 231 may be configured to compute cascade scores as described herein. The adversarial training module 230 may further include a perturbation submodule 232 (e.g., similar to adversarial loss module 115 in FIG. 1). Perturbation submodule 232 may be configured to perturb item embeddings as described herein. The adversarial training module 230 may further include a training submodule 233. Training submodule 233 may be configured to train a sequential recommendation model using perturbed user interaction sequences as described herein. In one embodiment, the adversarial training module 230 and its submodules 231-233 may be implemented by hardware, software and/or a combination thereof.

In one embodiment, the adversarial training module 230 and one or more of its submodules 231-233 may be implemented via an artificial neural network. The neural network comprises a computing system that is built on a collection of connected units or nodes, referred as neurons. Each neuron receives an input signal and then generates an output by a non-linear transformation of the input signal. Neurons are often connected by edges, and an adjustable weight is often associated to the edge. The neurons are often aggregated into layers such that different layers may perform different transformations on the respective input and output transformed input data onto the next layer. Therefore, the neural network may be stored at memory 220 as a structure of layers of neurons, and parameters describing the non-linear transformation at each neuron and the weights associated with edges connecting the neurons. An example neural network may be [use the one that is discussed in the data experiment section], and/or the like.

In one embodiment, the neural network based adversarial training module 230 and one or more of its submodules 231-233 may be trained by updating the underlying parameters of the neural network based on the loss described in relation to FIG. 1B. For example, the loss described in Eq. (10) is a metric that evaluates how far away a neural network model generates a predicted output value from its target output value (also referred to as the “ground-truth” value), and how far away internal representations are when perturbed from their unperturbed counterparts. Given the loss computed according to Eq. (10), the negative gradient of the loss function is computed with respect to each weight of each layer individually. Such negative gradient is computed one layer at a time, iteratively backward from the last layer to the input layer of the neural network. Parameters of the neural network are updated backwardly from the last layer to the input layer (backpropagating) based on the computed negative gradient to minimize the loss. The backpropagation from the last layer to the input layer may be conducted for a number of training samples in a number of training epochs. In this way, parameters of the neural network may be updated in a direction to result in a lesser or minimized loss, indicating the neural network has been trained to generate a predicted output value closer to it target output value.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

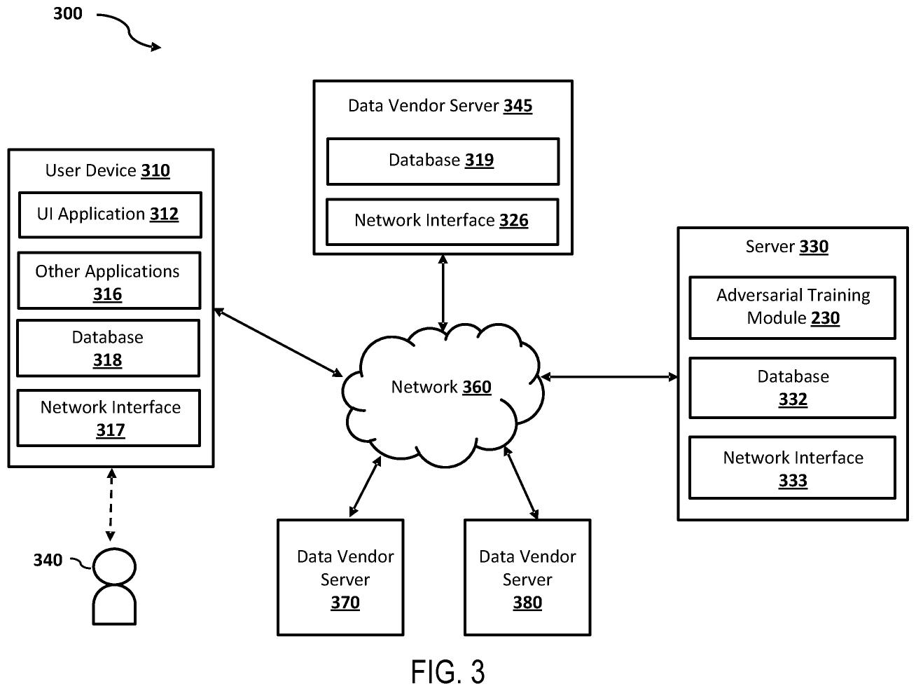

FIG. 3 is a simplified block diagram of a networked system 300 suitable for implementing the cascade-guided adversarial training framework described herein. In one embodiment, system 300 shows includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating user item recommendations from the server 330 and display the message via the UI application 312. In other embodiments, user device 310 may include additional or different modules having specialized hardware and/or software as required.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view item recommendations.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including user interaction sequences to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the adversarial training module 230 and its submodules described in FIG. 1. In some implementations, adversarial training module 230 may receive data from database 319 at the data vendor server 345 via the network 360 to generate a sequential recommendation model, and/or item recommendations at inference. The generated sequential recommendation model or recommendations may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the adversarial training module 230. In one implementation, the database 332 may store previously generated recommendations, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Embodiments

FIG. 4 illustrates an example of applying adversarial training on sequential recommendation according to some embodiments. As illustrated, user sequence Vᵢ contains items 402-406, which appear in the sequence at times 1 to T respectively. An encoder may embed those items to provide embeddings 414-418. These embeddings represent those items in a latent representation space. In order to perform cascade-guided adversarial training, perturbations are applied to the item embeddings corresponding to their respective cascade effects. The perturbations 420-424 as illustrated are added to item embeddings 414-417. Each of the perturbations 420-424 may be computed using the respective cascade scores as discussed in more detail with respect to FIG. 5. The cascade score may be used to scale a computed value which represents the computed worst-case gradient for perturbation, for example, computed as discussed with respect to equation (7).

The aggregated user embedding wᵢ may also be perturbed by perturbation 434, and target item embedding 432 may be perturbed bay perturbation 436. These perturbations may be generated based on equation (9) as discussed above in addition to a perturbation for a negative item used for a loss such as a BCE loss which uses a positive and negative item to generate the loss. As discussed above regarding equation (10), one or more losses may be computed and summed to provide an overall loss which is used to train the sequential recommendation model. The losses may include a non-perturbed BCE loss, a first adversarial loss based on the change in user embeddings under item-embedding perturbation, and a second adversarial loss based on perturbations to the user, target item, and negative sampled item embeddings. Note that the adversarial losses described here may be computed not with respect to the final output (next recommended item), but with respect to a change in embeddings based on perturbation, and therefore may be considered “virtual” adversarial training.

FIG. 5 illustrates an example of calculating cascade effects according to some embodiments. Note that many different methods may be used to calculate cascade effects. Generally, the cascade score is based on the position of the item in the training sequence, and may also consider the position of the same item in other training sequences. The following description is one example of a cascade score calculation that may be performed.

When training a sequential recommendation model, each user-item interaction produces cascade effects. For a given user-item interaction, two types of interactions receive its cascade effects: (1) all interactions following the given interaction, within the same user history sequence; (2) all interactions with the same item occurring in different user history sequences within the same training batch. This is illustrated in FIG. 5.

Based on the above observation, for an item vₜⁱ for which user i interacted at timestamp t, the cascade effect C(i,t) may be defined as:

$$C ( i , t ) = 1 + T - t + \frac{b}{m} {\sum }_{k ∈ u} {\sum }_{l \leq T} ( 1 + T - l ) 𝕀 ( {v}_{i ,}^{t} {v}_{k}^{l} ) \qquad ( 11 )$$

$$𝕀 ( {v}_{i ,}^{t} {v}_{k}^{l} ) = \{ \begin{matrix}1 , & if {v}_{i}^{t} = {v}_{k}^{l} \\ 0 , & otherwise\end{matrix} \qquad ( 12 )$$

Here, b is the batch size during training and b/m approximates the probability of two user sequences appearing in the same training batch. After calculating C, its inverse will be a real number in (0, 1], and this will be used to re-normalize the magnitudes of adversarial perturbations.

Note that in Eq. (11), 1+T−t calculates the cascade effects that directly comes from the temporal information in the same user history, i.e., the inverse of timestamp. The accumulative term calculates the cascade effects that comes from the same item in different user sequences.

The example illustrated in FIG. 5 is computing the cascade score for item 512 in sequence 506. Since item 512 is the fourth item from the end of sequence 506, it may start with a local cascade score of 4 as shown in equation (11) as 1+T−t. Sequence 504 does not contain that same item (illustrated here as binoculars), so does not contribute to the cascade score. The same item does appear in sequences 502 and 508. For sequence 502, item 510 appears in the fifth position from the end of the sequence, giving it a score of 5, and in sequence 508, item 514 appears at the second position from the end of the sequence, giving it a score of 2. These two scores are summed, giving a value of 7. The value of 7 is then scaled by the b/m factor to account for batch sizes less than the entire collection of sequences. Assuming the batch size is equal to the amount of sequences (b=m), the cascade score for item 512 would be 4+7=11 as shown. In some algorithms, the same sequence as the item of interest (here sequence 506) may be included in the calculation twice. Once for the local cascade score (1+T−t), and again in the sum which is scaled by b/m. In general where b<m, the extra contribution of the same sequence is negligible, while the simplicity of not skipping the sequence in performing the calculation may be preferred. In some embodiments, however, the same sequence may be skipped when performing the sum over the other sequences. As described herein, the computed cascade scores may be used to perturb item embeddings. For example, as shown here, assuming b=m, item 512 has a cascade score of 11. This cascade score may be applied to the embedding of item 512, for example, as described in equation (6).

### Example Work Flows

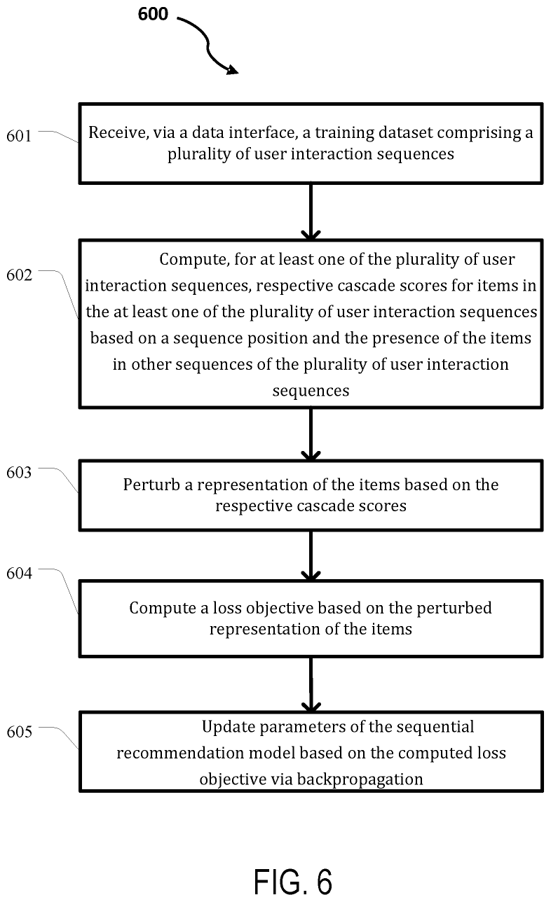

FIG. 6 is an example logic flow diagram illustrating a method of training a sequential recommendation model based on the framework shown in FIGS. 1-5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the adversarial training module 230 (e.g., FIGS. 2-3).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a system receives, via a data interface (e.g., data interface 215 of FIG. 2), a training dataset comprising a plurality of user interaction sequences (e.g., input sequences 102 of FIG. 1). These sequences may represent user behaviors, for example items which a user has purchased, or otherwise interacted with, from an online catalog.

At step 602, the system computes, for at least one of the plurality of user interaction sequences, respective cascade scores (e.g., as by cascade score module 113 of FIG. 1b, or cascade score submodule 231 of FIG. 2) for items in the at least one of the plurality of user interaction sequences based on a sequence position and the presence of the items in other sequences of the plurality of user interaction sequences. Cascade scores may further be based on the sequence position of the items in other sequences. For example, as discussed with respect to FIG. 5, a cascade score for an item may include a “local” cascade score based on the position of the item in the sequence relative to the last position of the sequence, in addition to summing position-based scores for other sequences in which that same item appears. The sum of “other” sequence scores may be scaled based on a factor which accounts for the probability that sequence appears in a training batch during the training process (e.g., batch size divided by the number of sequences). In some embodiments, the sequence containing the item for which the cascade score is being computed is included for both the “local” cascade score and in the sum of the remaining sequences.

At step 603, the system perturbs (e.g., as by adversarial loss module 115 of FIG. 1b, or perturbation submodule 232 of FIG. 2) a representation of the items based on the respective cascade scores. This may be done, for example, as described with respect to equations (6) and (7). The cascade score may be used to scale a vector which is determined based on the worst case direction for perturbation, determined by calculating a gradient such as in equation (7).

At step 604, the system computes a loss objective based on the perturbed representation of the items. The loss objective may also be based on non-perturbed representation of the items. For example, as discussed with respect to equation (6), the loss may be a measure of a comparison of the aggregated embeddings of the items for perturbed and non-perturbed embeddings. While this loss is not a loss which is directly related to the final output of a next-item prediction (i.e., it is a “virtual” adversarial loss), it may allow the model to be more robust to noisy input data.

At step 605, the system updates parameters of the sequential recommendation model based on the computed loss objective via backpropagation (e.g., training submodule 233 of FIG. 2). The parameters may be updated based on additional loss objectives, for example as discussed with respect to equation (10). A general binary cross entropy (BCE) loss may be used for standard training of next-item prediction. A second adversarial loss may be computed (e.g., according to equations 8 and 9) which utilizes perturbed representations of the user embedding, target item embedding, and/or the negative item embedding. The various losses may be aggregated, for example by using a weighted sum, so that the model training may account for the different losses together. Updating parameters may include updating neural network parameters and/or values in an item-embedding matrix which defines how items are represented by their embeddings.

In some embodiments, the training of the sequential recommendation model may be performed in stages. For example, an initial phase may be performed without adversarial losses included. Once the model has converged, a second stage may be performed which includes one or more adversarial losses.

The resulting sequential recommendation model may be used to predict a next-item in a sequence. For example, a user may use a UI application (e.g., UI application 312 of FIG. 3) in which they interact with a sequence of items. The UI application may display a next-item recommendation based on the sequence of items as predicted by a model trained as described herein.

### Example Results

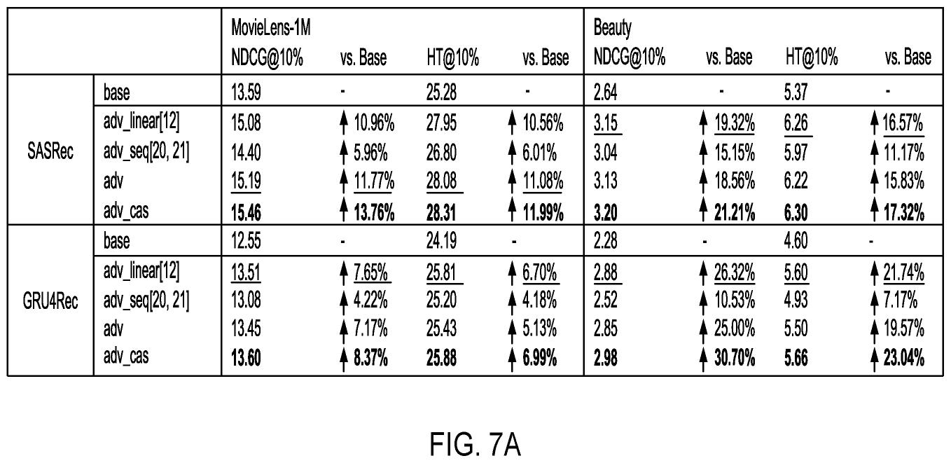

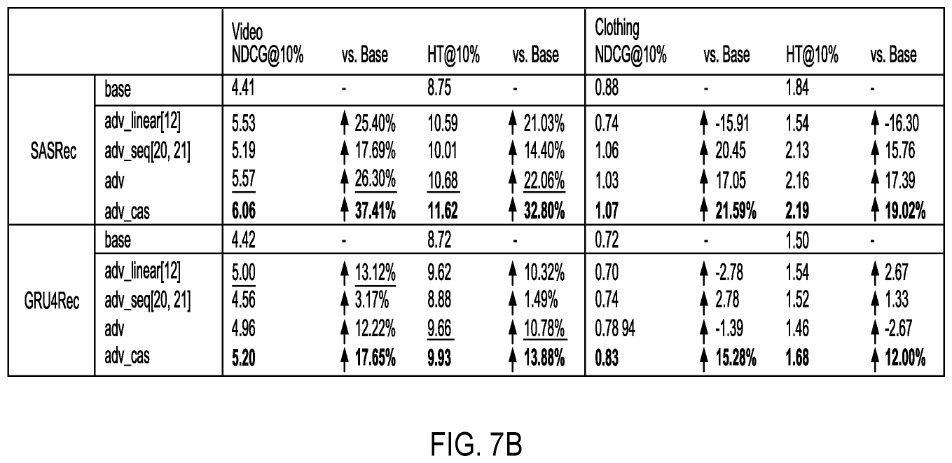

FIGS. 7-11 provide charts illustrating exemplary performance of different embodiments described herein.

Results illustrated represent experiments on public datasets from completely different domains with diverse densities. MovieLens-1M, which is a recommendation dataset that consists of users' ratings on movies. It has 1 million ratings from over 6,000 users on over 3,000 movies. Amazon-Video, Amazon-Beauty & Amazon-Clothing are Amazon review datasets which contain user ratings on products in the Amazon e-commerce system. From 29 available datasets in different product categories, experimental results illustrated represent Video, Beauty, and Clothing datasets.

For base models, two deep sequential recommender systems were used with different model structures as the base models: GRU4Rec as described in Hidasi et al., Session-based recommendations with recurrent neural networks, arXiv:1511.06939, 2015; and SASRec as described in Kang et al., Self-attentive sequential recommendation, In 2018 IEEE international conference on data mining (ICDM), 197-206, 2018. GRU4Rec utilizes RNNs to learn user preferences based on their history sequences. SASRec relies on attention mechanisms that can dynamically learn the attention weights on each interaction in the user sequences.

In the specific tested implementation, first, exactly the same architectures for the base models were used as described in their original papers. A single layer of GRU units was used in the GRU4Rec model and 2 self-attention blocks in the SASRec model with hidden size of 100. The maximum sequence length T is set to 200 for MovieLens-1M and 50 for Video, Beauty and Clothing datasets according to their different densities.

The same training strategy was used for training all the models on all the datasets: first train the base models for 500 epochs to ensure their convergence, then apply Adversarial Training (generic and the method described herein) on the trained models for further 100 epochs. For both of the training phases, Adam optimizer was used as described in Kingma et al., Adam: A method for stochastic optimization, arXiv:1412.6980, 2014. The Adam optimizer was configured with 0.001 learning rate. The batch size is 128 and a 0.2 dropout rate and 1×10⁻⁵ L₂ norm to prevent overfitting. A leave-one-out strategy was followed to split training and test data, which is commonly used in sequential recommendation.

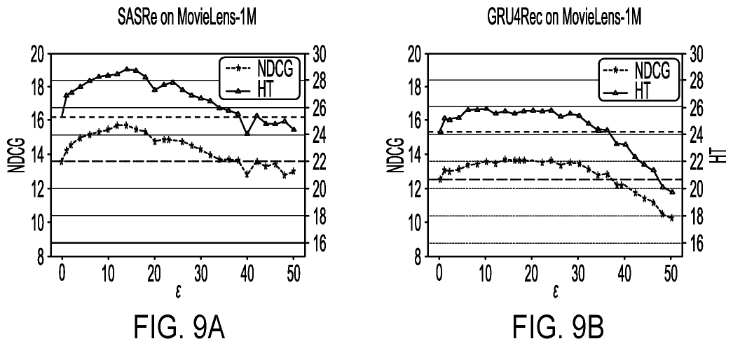

For the hyper-parameters, the magnitude ϵ for the purpose of these results was always set to 10 for all the datasets. An ablation study on different ϵ values is discussed with respect to FIG. 9. For parameters 11 and 12 in Eq. (10) are set to 1 for the illustrated results such that the three loss functions equally contribute to the training. Note that in the embodiments used to produce the illustrated results there is no hyper-parameter used to compute the cascade effects, which means the proposed adversarial training method can be easily applied on new datasets and models without additional tuning effort.

FIG. 7 illustrates the extent to which the proposed adversarial training method can improve the ranking accuracy in comparison to baseline adversarial training methods. One training method used for comparison is Adv_linear as described in He et al., Adversarial personalized ranking for recommendation, In the 41^{st} International ACM SIGIR Conference on Research & Development in Information Retrieval, 355-364, 2018. Adv_linear is an adversarial training method designed for MF-based recommender systems, which only applies the adversarial perturbation on the target user and item embeddings. In the sequential recommendation setting, this corresponds to applying perturbations only at the second level of the sequential recommendation model hierarchy, on wᵢ and eⱼ.

Another training method used for comparison is Adv_sequence as described in Miyato et al., Adversarial training methods for semi-supervised text classification, arXiv: 1605.07725, 2016. Adv_sequence is an adversarial training method originally applied on an LSTM model for text classification. It is applied on sequential recommendation as described in Manotumruksa et al., Sequential-based Adversarial Optimisation for Personalised Top-N Iten Recommendation, In Proceedings of the 43^{rd} International ACM SIGIR conference on research and development in Information Retrieval, SIGIR 2020, Virtual Even, China, July 25-30, 2045-2048, 2020. Though they are also applied on sequential models, these methods only add adversarial perturbations on the sequence embeddings.

Adv_global is a self-defined baseline. The same two-leveled adversarial training strategy as our proposed method was used but without cascade-guided re-normalization. Comparing to this baseline can be also seen as an ablation study of how much the cascade values contribute to the improvement of accuracy.

Note that for fair comparison, when implementing the method described herein, the average cascade values are re-normalized to 1 so that the total magnitudes of added perturbations are the same for all the baselines. As shown in FIG. 7, compared to the pre-trained base models (no adversarial training), applying any of the adversarial training methods can generally further improve the ranking accuracy. This means that while adversarial training improves the models robustness on the adversarial examples, it also improves the models generalization on the clean data. Second, the Cascade-Guided Adversarial Training method consistently outperforms all the other baselines on all the datasets. On average, it improves the ranking accuracy of the base model by 15.32% for SASRec and 15.99% for GRU4Rec. Compared to the second best baselines, it shows 18.16% more improvement of the base model for SASRec and 168.94% for GRU4Rec. Third, the improvements on the sparser datasets (i.e., Video, Beauty, and Clothing) are more significant than the other datasets. This is expected since when training complicated deep neural networks on sparse datasets, the trained models more easily overfit on the data and become less stable. Note that all the other adversarial training methods fail to improve GRU4Rec on the Clothing dataset possibly due to its extreme sparsity, but the cascade-guided adversarial training method still performs well.

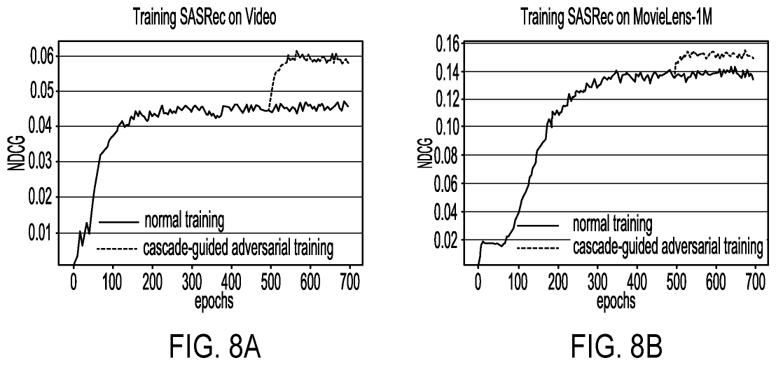

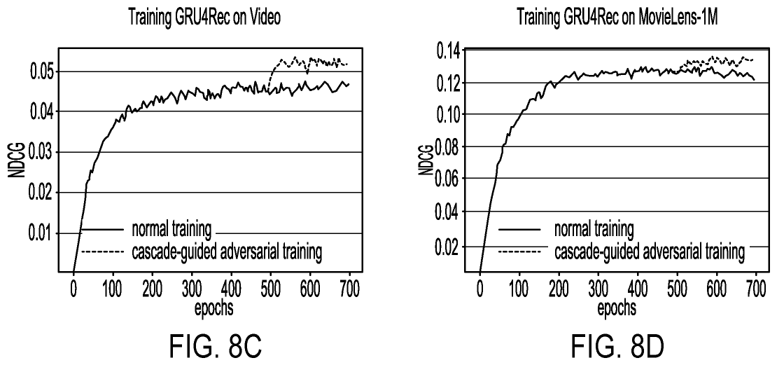

FIG. 8 illustrates the learning curves of the two training phases. As shown in the figures, the base models converge in the first 500 epochs of pre-training. Training for more epochs can hardly benefits the trained models. However, when applying the Cascade-guided Adversarial Training, the ranking accuracy can be quickly improved further.

FIG. 9 illustrates the effect of the magnitude of the adversarial perturbations. Too little perturbation may not sufficiently improve the models' robustness. On the contrary, if the magnitudes of the perturbations are too large, the model may not learn any useful information. The magnitude of perturbations is controlled by the hyper-parameter e in equations (7) and (9). The value of ϵ was set compared 0.1 to 50 as shown in FIG. 9. The first observation is the adversarial training algorithm described herein is effective for a range of ϵ values. Even a very small number of ϵ (e.g., 1) can significantly improve the models' performance. The method shows the best performance when ϵ∈[10, 20] for both base recommendation models. When e is larger than 30, the models' accuracy starts to drop, suggesting that the adversarial perturbations are too large, and useful information is lost during training. Therefore, an optimal e may be determined with by a user, or automatically by a system by adjusting e and determining the optimal value.

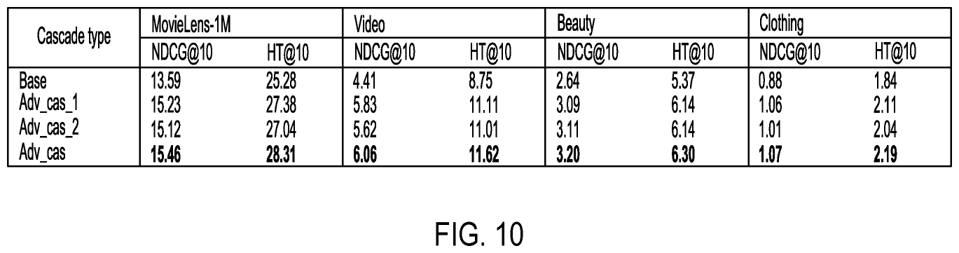

FIG. 10 illustrates an ablation study about how each component of cascade effects contribute to the final performance. As in Eq.(11), each interaction may have two types of cascade effects on other interactions (i.e., cascade effects on direct later interactions and cascade effects on the interactions from other sequences). As shown in FIG. 10, only considering single type of cascade effects (i.e., “local” cascade score described above) can still improve the trained models. However, the adversarial training method shows the best performance when considering both cascade effects.

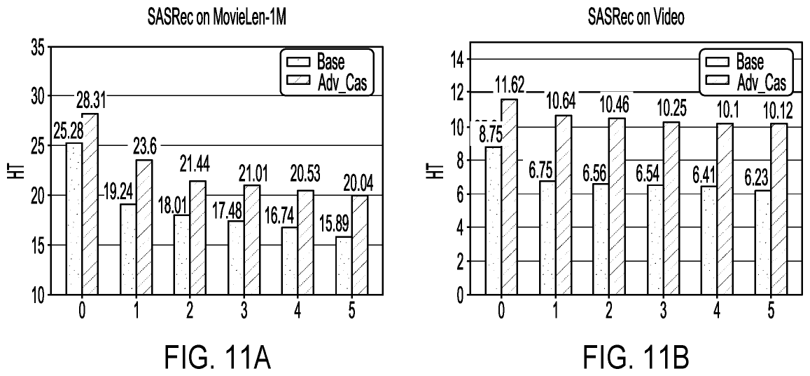

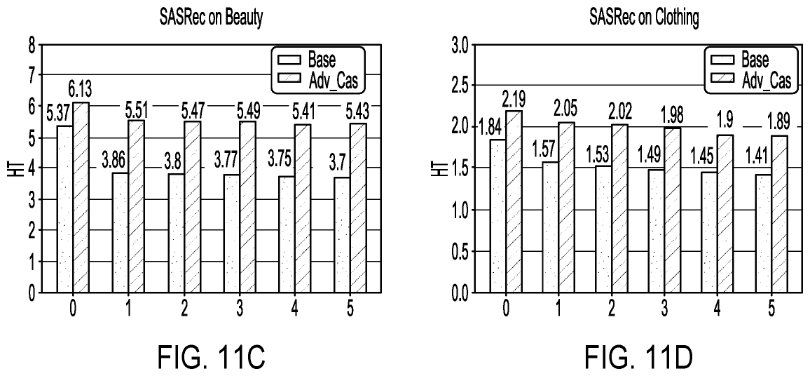

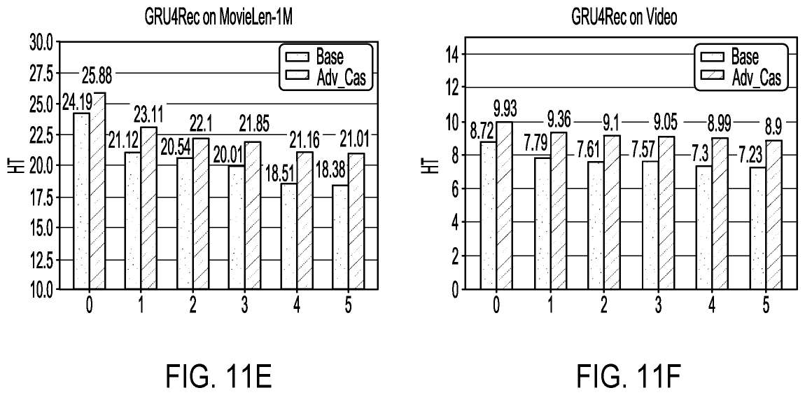

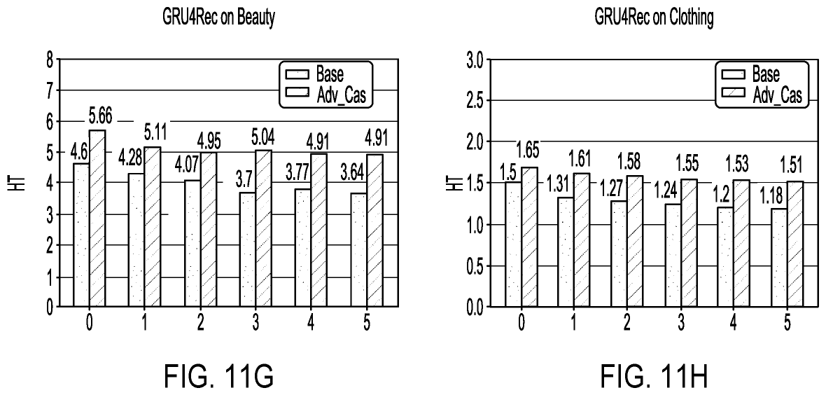

FIG. 11 illustrates model robustness by replacing the last K items in user sequences. K was selected from 1 to 5 to show the trend of decreasing model accuracy. These experiments were performed for both base models on all the four datasets. The results clearly show that the models trained with our Cascade-guided Adversarial Training consistently outperform the original models. Meanwhile, the decreasing accuracy is generally slower in most cases except for GRU4Rec on MovieLens-1M dataset, which shows similar percentage of decrease. The results show that the proposed training method indeed improves the model robust-ness for small perturbations. Note that for the Video, Beauty, and clothing datasets, even by changing the last 5 items in the original user sequence, the ranking accuracy is still higher than the normally trained models on clean data. This shows that the Cascade-guided Adversarial Training method described herein is significantly effective on sparse datasets.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a sequential recommendation model, the method comprising:
receiving, via a data interface, a training dataset comprising a plurality of user interaction sequences for a user;
computing, for at least one of the plurality of user interaction sequences, respective cascade scores for items in the at least one of the plurality of user interaction sequences based on a sequence position and the presence of the items in other sequences of the plurality of user interaction sequences;
generating, via the sequential recommendation model, a recommendation score relating to a target item for the user;
computing a first loss based on the generated recommendation score;
perturbing embeddings of the items based on the respective cascade scores;
computing a second loss based on the perturbed embeddings of the items; and
updating parameters of the sequential recommendation model based on the first loss and the second loss via backpropagation.

2. The method of claim 1, wherein the respective cascade scores are computed by assigning a higher score to items in earlier positions in their respective user interaction sequences.

3. The method of claim 2, wherein at least one cascade score for a first item in a first user interaction sequence is computed by adding a local cascade score, computed as a sequence position of the first item subtracted from a length of the first user interaction sequence, and a scaled sum of external cascade scores, computed based on respective sequence positions for sequences which include the first item.

4. The method of claim 1, the computing the second loss further comprising:
generating a first user embedding based on embeddings of the items;
generating a second user embedding based on the perturbed embeddings of the items; and
computing the second loss by computing a difference between the first user embedding and the second user embedding.

5. The method of claim 1, wherein the perturbing the embeddings of the items includes:
determining a worst case perturbation direction based on a gradient of a function defining the second loss, and
perturbing the embeddings of the items based on the determined worst case perturbation direction.

6. The method of claim 1, further comprising:
generating a second recommendation score using at least one of:
a perturbed user embedding;
a perturbed target item embedding; or
a perturbed negative item embedding; and
computing a third loss based on the second recommendation score,
wherein the updating parameters is further based on the third loss.

7. The method of claim 6, wherein at least one of the perturbed user embedding, perturbed target item, or perturbed negative item embedding is perturbed by determining a worst case perturbation direction based on one or more gradients of a function defining the third loss.

8. The method of claim 6, wherein updating the parameters is based on a combined loss objective including a weighted sum of the first loss, the second loss, and the third loss.

9. A system for training a sequential recommendation model, the system comprising:
a memory that stores the sequential recommendation model and a plurality of processor executable instructions;
a communication interface that receives a training dataset comprising a plurality of user interaction sequences for a user; and
one or more hardware processors that read and execute the plurality of processor-executable instructions from the memory to perform operations comprising:
computing, for at least one of the plurality of user interaction sequences, respective cascade scores for items in the at least one of the plurality of user interaction sequences based on a sequence position and the presence of the items in other sequences of the plurality of user interaction sequences;
generating, via the sequential recommendation model, a recommendation score relating to a target item for the user;
computing a first loss based on the generated recommendation score;
perturbing embeddings of the items based on the respective cascade scores;
computing a second loss based on the perturbed embeddings of the items; and
updating parameters of the sequential recommendation model based on the first loss and the second loss via backpropagation.

10. The system of claim 9, wherein the respective cascade scores are computed by assigning a higher score to items in earlier positions in their respective user interaction sequences.

11. The system of claim 10, wherein at least one cascade score for a first item in a first user interaction sequence is computed by adding a local cascade score, computed as a sequence position of the first item subtracted from a length of the first user interaction sequence, and a scaled sum of external cascade scores, computed based on respective sequence positions for sequences which include the first item.

12. The system of claim 9, the computing the second loss further comprising:
generating a first user embedding based on embeddings of the items;
generating a second user embedding based on the perturbed embeddings of the items; and
computing the second loss by computing a difference between the first user embedding and the second user embedding.

13. The system of claim 9, wherein the perturbing the embeddings of the items includes:
determining a worst case perturbation direction based on a gradient of a function defining the second loss, and
perturbing the embeddings of the items based on the determined worst case perturbation direction.

14. The system of claim 9, further comprising:
generating a second recommendation score using at least one of:
a perturbed user embedding;
a perturbed target item embedding; or
a perturbed negative item embedding; and
computing a third loss based on the second recommendation score,
wherein the updating parameters is further based on the third loss.

15. The system of claim 14, wherein at least one of the perturbed user embedding, perturbed target item, or perturbed negative item embedding is perturbed by determining a worst case perturbation direction based on one or more gradients of a function defining the third loss.

16. The system of claim 14, wherein updating the parameters is based on a combined loss objective including a weighted sum of the first loss, the second loss, and the third loss.

17. A non-transitory machine-readable medium comprising a plurality of machine-executable instructions which, when executed by one or more processors, are adapted to cause the one or more processors to perform operations comprising:
receiving, via a data interface, a training dataset comprising a plurality of user interaction sequences for a user;
computing, for at least one of the plurality of user interaction sequences, respective cascade scores for items in the at least one of the plurality of user interaction sequences based on a sequence position and the presence of the items in other sequences of the plurality of user interaction sequences;
generating, via a sequential recommendation model, a recommendation score relating to a target item for the user;
computing a first loss based on the generated recommendation score;
perturbing embeddings of the items based on the respective cascade scores;
computing a second loss based on the perturbed embeddings of the items; and
updating parameters of the sequential recommendation model based on the first loss and the second loss via backpropagation.

18. The non-transitory machine-readable medium of claim 17, wherein the respective cascade scores are computed by assigning a higher score to items in earlier positions in their respective user interaction sequences.

19. The non-transitory machine-readable medium of claim 18, wherein at least one cascade score for a first item in a first user interaction sequence is computed by adding a local cascade score, computed as a sequence position of the first item subtracted from a length of the first user interaction sequence, and a scaled sum of external cascade scores, computed based on respective sequence positions for sequences which include the first item.

20. The non-transitory machine-readable medium of claim 17, the computing the second loss further comprising:
generating a first user embedding based on embeddings of the items;
generating a second user embedding based on the perturbed embeddings of the items; and
computing the second loss by computing a difference between the first user embedding and the second user embedding.
